(19) United States
(12) Patent Application Publication
(10) Pub. No.: US 2014/0025433 A1
(43) Pub. Date: Jan. 23, 2014

(54) ELECTRONIC SYSTEM FOR VALUATION AND AN ELECTRONIC PROCESS FOR SAME

(71) Applicant: PUROSYSTEMS, INC., (US)

(72) Inventor: STEVEN PAUL LEGER, CORAL SPRINGS, FL (US)

(73) Assignee: PUROSYSTEMS, INC., TAMARAC, FL (US)

(21) Appl. No.: 13/861,155

(22) Filed: Apr. 11, 2013

Related U.S. Application Data
(60) Provisional application No. 61/623,438, filed on Apr. 12, 2012.

(51) Int. Cl. G06Q 30/02

(52) U.S. Cl. CPC G06Q 30/0206
USPC 705/7.35

(57) ABSTRACT

A computerized system and process, comprising storing characteristics of possible products in an electronic database, accepting user input related to a product's characteristics, matching the accepted user input related to the product's characteristics to the electronic database of characteristics of possible products to find a matched product, and determining, using the retail pricing calculation engine, a valuation for the a matched product.

### CROSS-REFERENCE TO RELATED APPLICATIONS

This application claims the benefit of U.S. Provisional Application No. 61/623,438, filed Apr. 12, 2012, which is incorporated by referenced in its entirety.

### BRIEF DESCRIPTION OF THE DRAWINGS

FIG. 1 illustrates a system for valuating a floor covering, according to an embodiment.

FIG. 2 illustrates a view of a custom gauge that may be used to measure stitch rates and pile heights in various queries, according to an embodiment.

FIG. 3 illustrates a view of the reference folders 55 which may contain samples of the texture types and backings that may be referenced in the query process, according to an embodiment.

FIGS. 4A-4B illustrate an example of the contents of the master query product database, according to an embodiment.

FIGS. 5-15 are method flowcharts illustrating numerous logic elements that may be encountered within system, according to an embodiment.

FIG. 16 illustrates an example of a master query match database, according to an embodiment.

### DETAILED DESCRIPTION OF EMBODIMENTS OF THE INVENTION

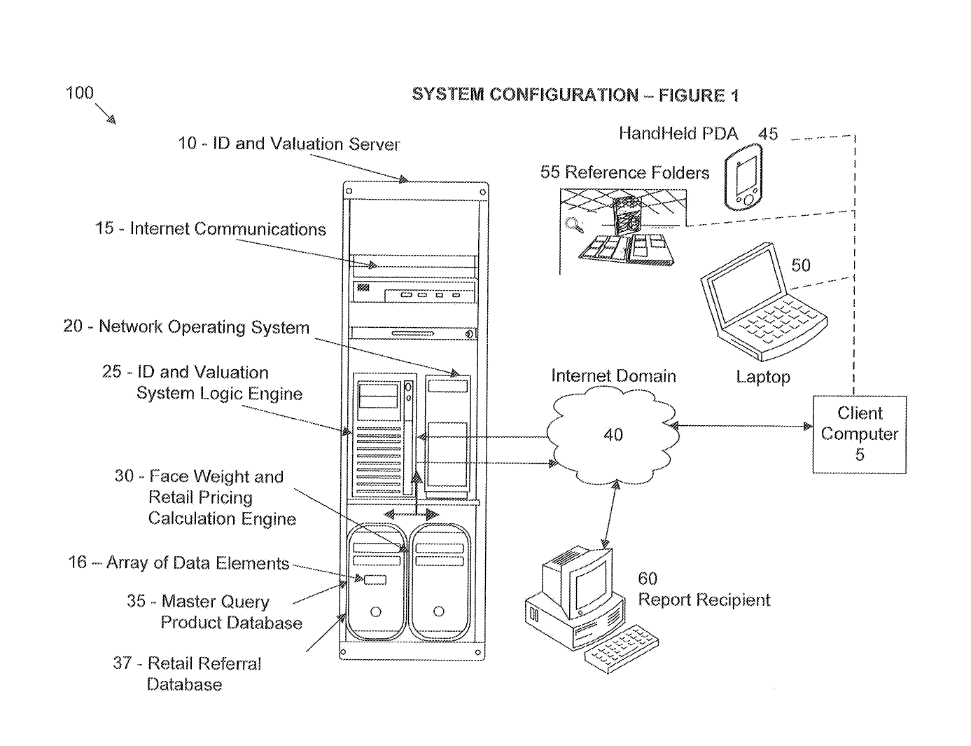

FIG. 1 illustrates a system 100 for valuating a floor covering, according to an embodiment. Note that, while the example carpet is used throughout this application, that any type of surface may be valuated. System 100 may help determine a Like Kind Quality (LKQ) to identify or describe a product that is similar in appearance, quality and value to a product being replaced after suffering damage, loss, or decay. (1 he acronym “LKQ” may be used to describe a product or material that is similar in appearance, quality and value to that which is being replaced after suffering damage or total loss. LKQ may be a determinant of value to help ensure the policyholder will receive appropriate indemnity for that which they lost.) LKQ may help an insurance policyholder, claimant, or other entity receive appropriate compensation. In one embodiment, through visual, tactile, and measurement selections, and use of the various physical samples as a reference guide, the user is navigated through questions that help determine the LKQ. In some embodiments, once the product is adequately identified for LKQ, a replacement material price (e.g., reflective of the policyholder's local market) may be calculated.

System 100 may comprise: an identification (ID) and valuation server 10, an Internet domain 40, a report recipient 60, a client computer 5 (e.g. handheld personal digital assistant (PDA) 45, laptop 50, other computer device), or reference folders 55, or any combination thereof. The ID and valuation server 10 may calculate valuations for floor coverings using a network operating system. The ID and valuation server 10 may comprise: Internet communications 15, a network operating system 20, and ID and valuation system logic engine 25, a face weight and/or retail pricing calculation engine 30, a master query product database 35, or a retail referral database 37, or any combination thereof. The network operating system 20 may control the various interactions of the automated environment 100, comprising: screen displays, data exchanges, task management, Internet connectivity management, or general control of the applications present in system 100, or any combination thereof. The ID and valuation system logic engine 25 may: provide the screen interface to the user, perform the various computations programmed in system 100, control the defined logic query steps (e.g., determine what to ask the user in queries #1-#11 set forth below), interface the appropriate face weight calculation, or interface with the retail pricing calculation database, or any combination thereof. The face weight and retail pricing calculation engine 30 may house the static data elements associated with the automated process of calculating the face weight of the products itemized in the master query product database 35, and/or the data elements associated with the automated process of matching the appropriate unit retail pricing with the result of the query process involving the master query product database (e.g., determine what happens logically once the user enters answers in the queries #1-#11 set forth below). The master query product database 35 may contain an array of data elements 16. The database may comprise more than 41,000 unique flooring types comprising known possible construction characteristic variations. The retail referral database 37 may comprise information (e.g., names, locations, contact information, or marketing image, or any combination thereof) of retailers who have agreed to participate as possible suppliers as may be needed by the e owner of the damaged products being evaluated. The client computer 5 may be capable of Internet-based functionality to present the queries, capture the responses and interact with the ID and Valuation server 10. The result of the process may he sent as an electronic file to a chosen recipient 60 via an Internet-based computer. The reference folders 55 may house samples of actual carpet swatches representing many different types of manufacturing families (e.g., floor covering samples, carpet backings).

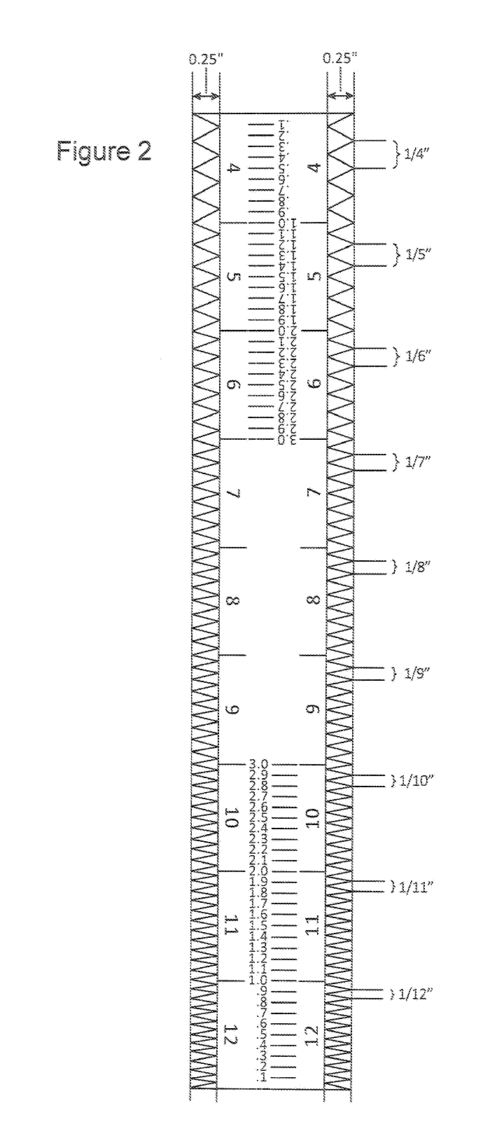

FIG. 2 illustrates a view of a custom gauge that may be used to measure stitch rates and pile heights in various queries. The gauge may be marked in nine one-inch sections with markers indicating from four to 12 tufts per one inch section. The user may be trained to use the gauge by placing the gauge along a row of tufts of the damaged carpet and moving the gauge horizontally until the tufts of the carpet align with the appropriate spaces between the markers. The gauge may also be marked with a vertical series of labels exactly 1/10 of an inch apart from 0.1 inch to 3.0 inches. This ruler of the gauge may be used to measure the short and long pile heights of the damaged carpet by placing the gauge at the backing of the carpet and visually assessing the height of the fiber against the ruler.

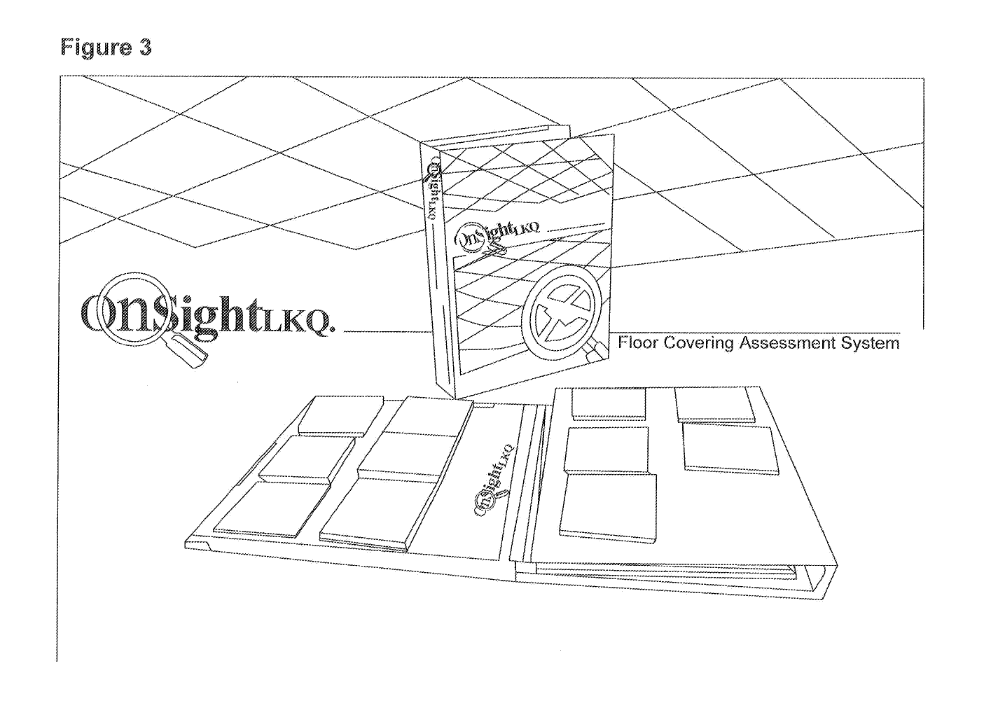

FIG. 3 illustrates a view of the reference folders 55 which may contain samples of the texture types and backings that may be referenced in the query process.

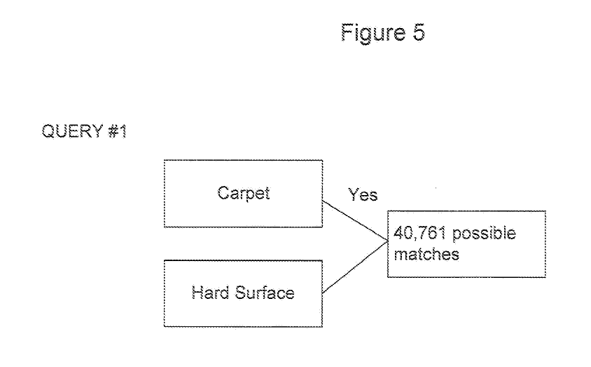

FIGS. 5-15 are method flowcharts illustrating numerous logic elements that may be encountered within system 100. To start using system 100, the user may log onto a secured web site with a password and then may key basic information about a policy holder, insurance company, claim number, location, etc. This may be done at the loss site or the user may cut a piece of the damaged carpet and perform the evaluation in another place (e.g., back at his office, in his car with a mobile Internet device (e.g., WIFI laptop, PDA). The user may perform a visual inspection of the damaged floor covering and proceed to answer a series of questions about the damaged product for identification purposes. As illustrated in FIGS. 5-15, in one example, the following manufacturing characteristic options may be chosen to determine the replacement floor covering option or options: carpet; broadloom, tufted, synthetic back, cut, Saxony, S/InW=7, S/InL=8, PHS=0.4; PHL=0.4; TB=base. The questions which lead to the chosen manufacturing characteristic options may refer to the following manufacturing characteristics:

#1: Product Family. (E.g., Carpet, Laminate, Engineered Wood, Solid Wood)

The user may select the product family that is to undergo the evaluation. FIG. 5 illustrates an example where the user is instructed to choose the type of floor covering. In this example, two choices are given: carpet or hard surface. At this point the user may select carpet. The query results may return all carpet options. In other embodiments, other choices may be provided.

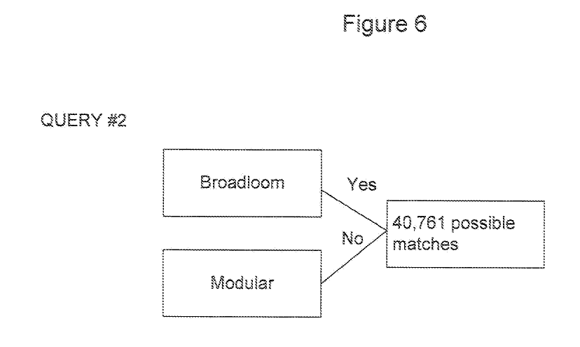

#2: Form. (E.g., Broadloom, Modular). The user may select the form that is to undergo the evaluation based on a visual inspection of the flooring material in question. FIG. 6 illustrates an example where the user is instructed to choose the form. In this example, two choices are given: broadloom or modular. Broadloom may refer to a “wall to wall” covering; modular may refer to a covering provided in units (e.g., tiles). The user then may select broadloom. The query results may return all broadloom options. In other embodiment, other choices may be provided.

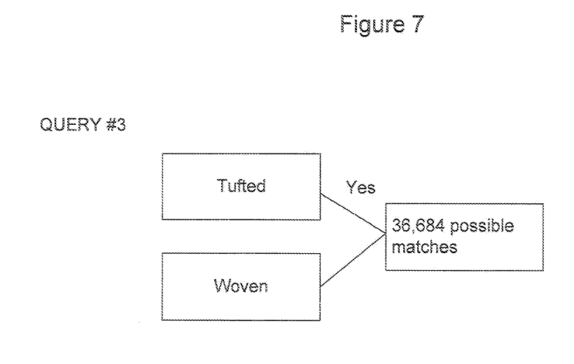

#3: Construction Type. (E.g., Tufted, Woven) Carpets may be manufactured through one of these two processes. The user may visually identify the difference in construction type. System 100 may display choices from which the user may select the appropriate selection. FIG. 7 illustrates an example where the user is instructed to choose the construction type (e.g., visual). In this example two choices are given: tufted or woven. The user then may select tufted. The query may return all tufted options. A certain percentage (e.g., 10% of the database may be excluded because they are woven). In other embodiments, other choices may be provided. Tufting may refer to a carpet manufacturing process whereby the carpet backing is run through a series of needles (e.g., as many as 12 per inch) which thrust fiber through the backing, thus creating a tuft of fiber in pre-defined rows and patterns. The fiber may be left in place and reinserted creating an appearance of a loop, or the fiber may be cut at the surface of the product. A woven carpet, sometimes made of wool or olefin, may refer to a carpet manufactured using a weaving process of continuous fiber. The result may be a carpet which may be constructed on a loom by interlacing the carpet warp and filling threads.

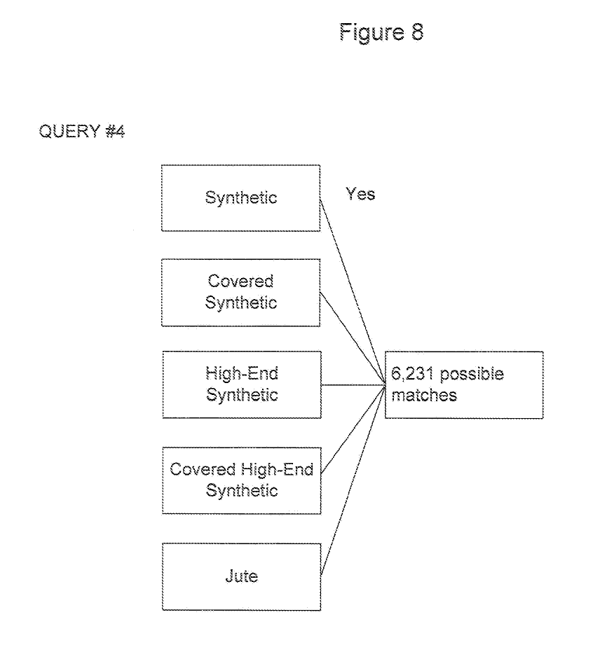

#4 Backing. (E.g., may be matched and selected from the reference folders 55). The reference folders 55 may contain photographic (e.g., visual) samples of the most common types of carpet backing materials used in the manufacture of residential and commercial carpeting. By sight and touch, the user may match the backing and select the ID number displayed. In some embodiments, the system logic n ay not let the user make invalid choices. For example, woven products are only manufactured on specific backings. Therefore, if woven is chosen in #3, only those backings that are specific to woven products may be displayed as possible selections. FIG. 8 illustrates an example where the user is instructed to choose the backing type. In this example, five backing choices are given for broadloom, tufted carpet: synthetic, covered synthetic, high-end synthetic, covered high-end synthetic, or jute. The user then may select synthetic. The query results may return all synthetic options. In other embodiments, other choices may be provided. Synthetic may indicate a backing that is made of laced LATEX™ and may be designed to accept tufts of synthetic fiber in a tufting process. Covered Synthetic may indicate a synthetic backing that is covered with a thin layer of cotton fiber used to protect walls during the installation process. High-end Synthetic may describe a backing that is made of laced LATEX™ and has a tighter weave of material to support greater fiber face weights. Covered High-End Synthetic may be a high-end synthetic back with a cotton covering.

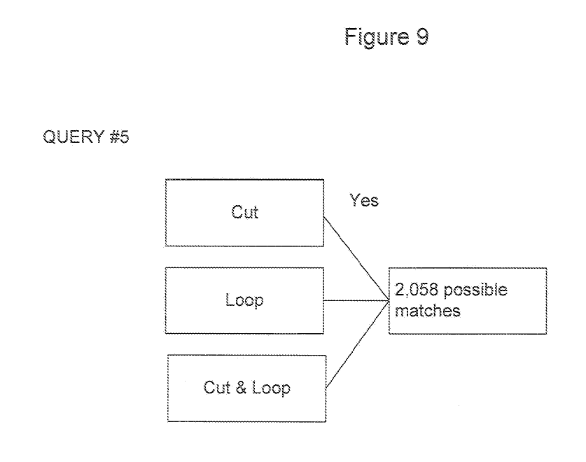

#5 Pile Configuration. (E.g., Cut, Loop, Cut&Loop) The user may be visually inspect the product and Identify (e.g., visually) the pile configuration. System 100 may display choices from which the user may select the appropriate selection after making a visual inspection. FIG. 9 illustrates an example where the user is instructed to choose the pile configuration. In this example, three choices are given: cut, loop, or cut and loop. The user then may select cut. The query results are further narrowed to carpet options having a cut pile configuration. In other embodiments, other choices may be provided. Cut pile may indicate that the yarn is cut at the top of the pile during the manufacturing process resulting in a flat appearance. Loop pile may indicate that the yarn is looped through the backing. Cut & Loop pile may be a manufacturing process that cuts some of the yarn while leaving others looped. This may result in a patterned appearance.

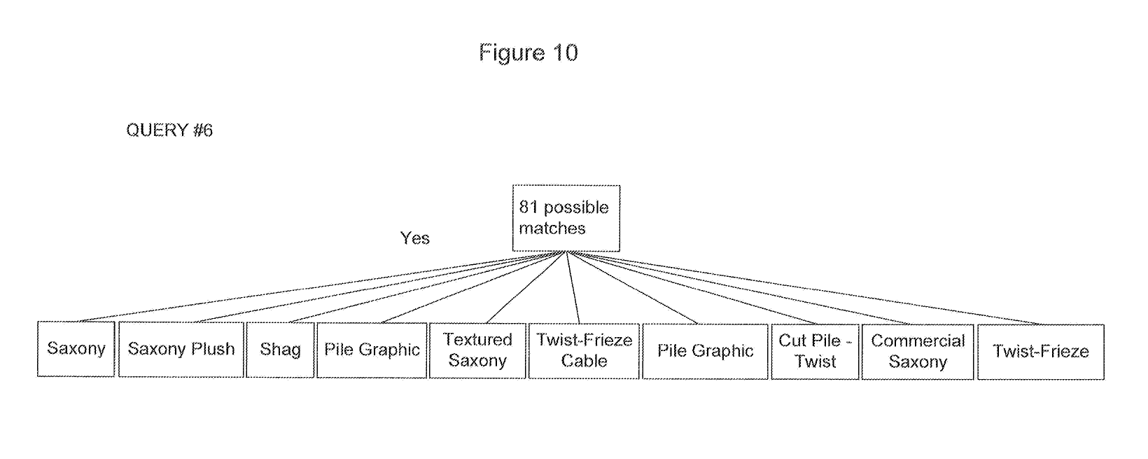

#6 Texture. (E.g., may be matched and selected from the reference folders 55). The user may identify (e.g., visually) the texture of the product. System 100 may display choices from which the user may select the appropriate selection after making a visual inspection (e.g., by matching their flooring to samples or otherwise using samples). FIG. 10 illustrates an example where the user is instructed to choose the texture. In this example, 10 choices are given because only 10 choices are possible matches for broadloom, tufted, synthetic, cut carpet: Saxony, Saxony plush, shag, pile graphic, textured Saxony, twist-frieze cable, cut pile-twist, commercial Saxony, or twist frieze. The user then may select saxony. The query results are further narrowed to options having a Saxony texture. In other embodiments, other choices may be provided. Saxony may refer to a cut pile product of average stitch rate density and pile height. Saxony Plush may refer to a cut pile product with a dense stitch rate and tall pile height. Shag may refer to a cut pile product with long fiber tufts (e.g., up to 3 inches) sometimes not dense or vertical in appearance. Pile graphic may refer to a cut pile product of average to low pile height and high stitch density, and may include a dyed pattern of tufts in a graphical design. Textured Saxony may refer to a cut pile Saxony product with slight variations in the ends of the vertical tufts creating a textured appearance. Twist-frieze cable may refer to a cut pile product with tufts of average to longer length and equal girth interlaced with a random sequence of much heavier girth tufts. The tufts in this category may be highly twisted and provide a “wormy” appearance. Cut pile twist may be similar to twist frieze cable, but this cut pile product may have equal length tufts (e.g., average to short) and possess a twisted appearance. Commercial Saxony may he similar to the Saxony, but may possess a more dense stitch rate and lower pile height. This product may be usually manufactured with a higher grade backing. Twist frieze may refer to a cut pile product with tufts of average to longer length and equal girth. The tufts in this category may be highly twisted and provide a “wormy” appearance. As may be done with any query, the system logic may only display those choices that are sensible (e.g., only those textures that are specific to the chosen pile configuration). For example, if the user chooses a cut pile configuration, system 100 may only display the following textures as a possible selection:

Cut Saxony

Cut Saxony Plush

Cut Shag

Cut Graphic

Cut Twist Frieze

Cut Twist Frieze Cable

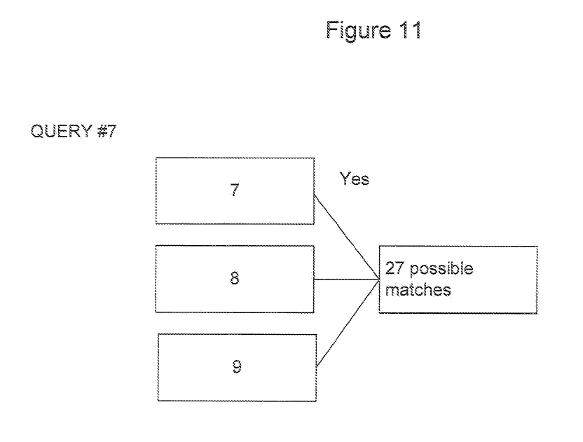

#7 Stitches Per inch (S/InW)—Width. (E.g., Measurement) The system logic may require a number of pile measurements in order to match the damaged flooring to the database used in as a basis of valuation. The user may be instructed to count the number of stitches in one inch across the width of the carpet. A ruler (e.g., as shown in FIG. 2) may be supplied to help the user identify the stitch count. FIG. 11 illustrates an example where the user is instructed to choose the stitches per inch for the width. In this example, three choices are given: seven, eight or nine. The user may be instructed to measure the stitches in one linear inch of the product being evaluated. This may be determined by inserting the ruled gauge to the base of the pile and aligning the tufts with the appropriate marks on the gauge. The user then may select 7 after making this measurement. The query results may then be further narrowed to broadloom, tufted, synthetic back, cut, Saxony carpet options (e.g., three in this example) having 7 stitches per inch for the width. In other embodiments, other choices may be provided. System 100 may only display the possible stitch counts that are consistent with the manufacturing process associated with the chosen pile configuration and texture.

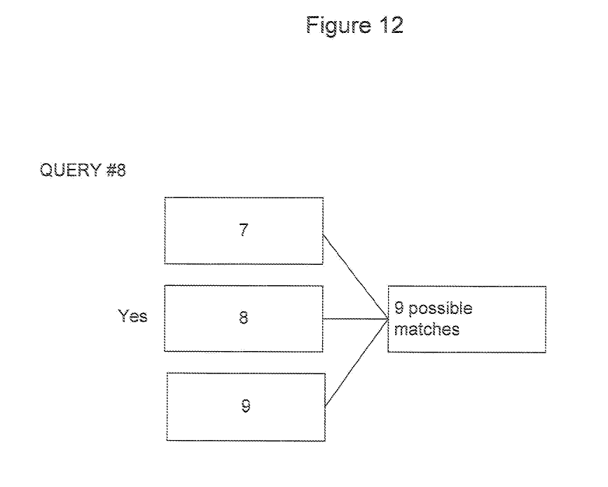

#8 Stitches Per inch (S/InL)—Length. (E.g., Measurement) Similar to the previous step, the user may he instructed to count the number of stitches in one inch perpendicular to the count taken in #7. The system logic may require a number of pile measurements in order to match the damaged flooring to the database used as a basis of valuation. The user may be instructed to count or measure the number of stitches in one inch across the width of the carpet. A ruler (e.g., as shown in FIG. 2) may be supplied to help the user identify the stitch count. FIG. 12 illustrates an example where the user is instructed to choose the stitches per inch for the length. In this example, three choices are given: seven, eight or nine. The user may measure the stitches in one linear inch perpendicular to the S/InW by inserting the ruled gauge to the base of the pile and aligning the tufts with the appropriate marks on the gauge. In this example, after measuring, the user may select 8. The query results may then be narrowed to broadloom, tufted, synthetic back, cut, Saxony, S/InW=7 carpet options (e.g., In this example, just three options) having 8 stitches per inch for the length. In other embodiments, other choices may be provided. System 100 may only display the possible stitch counts that are consistent with the manufacturing process associated with the chosen pile configuration and texture.

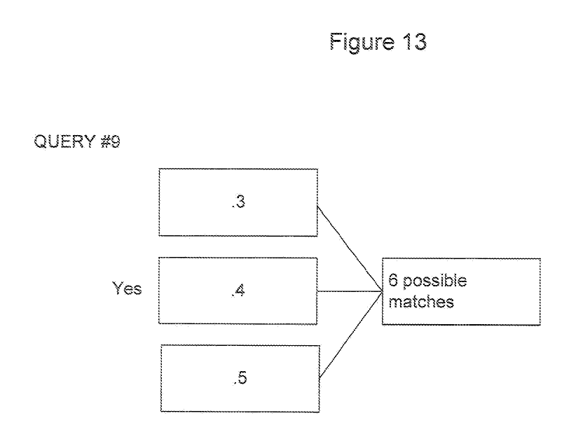

#9 Pile Height—Short (PHS). (E.g., Measurement) The user may be instructed to measure the short pile height (e.g., the shortest height of the pile) of the subject carpet in tenths of an inch. The user may be instructed to use a ruled gauge (e.g., as shown in FIG. 2) to measure the short pile height and select the matching entry. FIG. 13 illustrates an example where the user is instructed to choose the shortest pile height. In this example, three choices are given: 0.3, 0.4, or 0.5. The user may measure the short pile height by inserting the ruled gauge to the base of the pile and observing the result. After measuring, the user then may select 0.4. The query results may then be further narrowed to broadloom, tufted, synthetic back, cut, Saxony, S/InW=7, S/InL=8 carpet options (e.g., in this example, just three options) having a short pile height of 0.4. In other embodiments, other choices may be provided. System 100 may only display the possible pile heights that are consistent with the manufacturing process associated with the chosen pile configuration and texture.

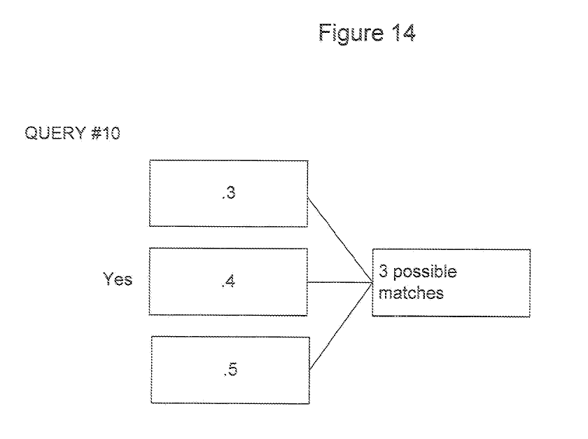

#10 Pile Long. (E.g., Measurement) The user may be instructed to measure the long pile height (e.g., longest height of the pile) of the subject carpet in tenths of an inch. The user may be instructed to use a ruled gauge (e.g., as shown in FIG. 2) to measure the longest pile height and select the matching entry. FIG. 14 illustrates an example where the user is instructed to choose the longest pile height. In this example, three choices are given: 0.3, 0.4, or 0.5. The user may measure the long pile height by inserting the ruled gauge to the base of the pile and observing the result. After measuring, the user then may select 0.4. The query results are further narrowed to broadloom, tufted, synthetic back, cut, Saxony, S/InW=7, SPH=0.4 carpet options having a longest pile height of 0.4. In other embodiments, other choices may be provided. System 100 may only display the possible longest pile heights that are consistent with the manufacturing process associated with the chosen pile configuration and texture.

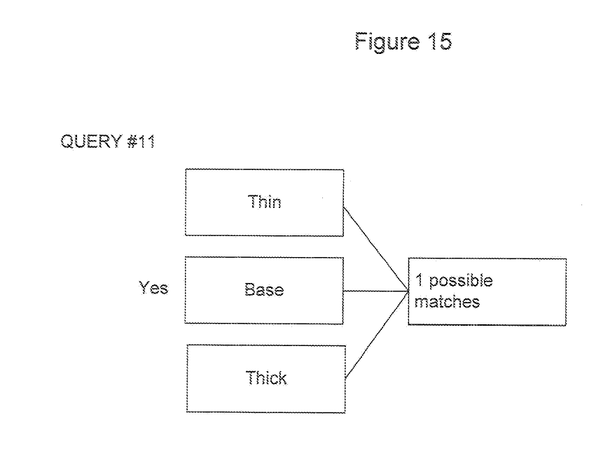

#11 Tuft Bulk (TB). The user may be instructed to choose the tuft bulk. The user may examine the overall thickness of the tufts of fiber in the product (e.g., as compared to those in the texture sample chosen in the folder). FIG. 15 illustrates an example where the user is instructed to choose the tuft bulk. In this example, three choices are given: thin, base, or thick. The user may be instructed to subjectively compare the tuft bulk of the tufts of the product being evaluated with one or more sample(s). After comparing, the user then may select base. The query results may be further narrowed to broadloom, tufted, synthetic back, cut, Saxony, S/InW=7, S/InL=8, PHS=0.4, PHL=0.4 carpet options having a base tuft bulk. In other embodiments, other choices may be provided. Thin may be chosen if the fiber appears thinner than that in the folder. Base may be chosen if the fiber is about the same as that in the folder. Thick may be chosen if the fiber appears thicker than that in the folder.

Note that all of the above logic may be done in other orders. In addition, note that the user may be trained to have the knowledge to answer the queries and/or the user may use the reference folders 55 to answer the queries. Also the above system will only provide possible options at each step/query based on the previous selected options.

### EXAMPLE

An example of the process set forth above is given below. The master query product database 35 may comprise thousands of unique line items (e.g., approximately 41,000). Each line item may be a set of data elements that correspond to the questions asked through the system 100. For example, in the realm of carpet manufacturing, it may be assumed that a Saxony product may be manufactured in a variety of pile tuft densities, pile heights and tuft weight or bulk. As such, it is feasible that an extremely low weight/density product may match the following:

Construction=Tufted

Backing=Synthetic

Pile Configuration=Cut

Texture Type=Saxony

Stitch Rate−Width=5

Stitch Rate−Length=5

Pile Height−Short=0.3

Pile Height−Long=0.3

Tuft Bulk=Thin

In this case, the carpet may equate to the lowest pile density and weight of any possible Tufted Saxony product. Thus, a product matching these characteristics may be at the lowest possible retail price point. Conversely, a Tufted Saxony product with maximum density of stitch rates, pile heights and tuft bulk may logically be at the highest possible retail price point. Between these two extremes there are hundreds of possible configurations of a Saxony style product.

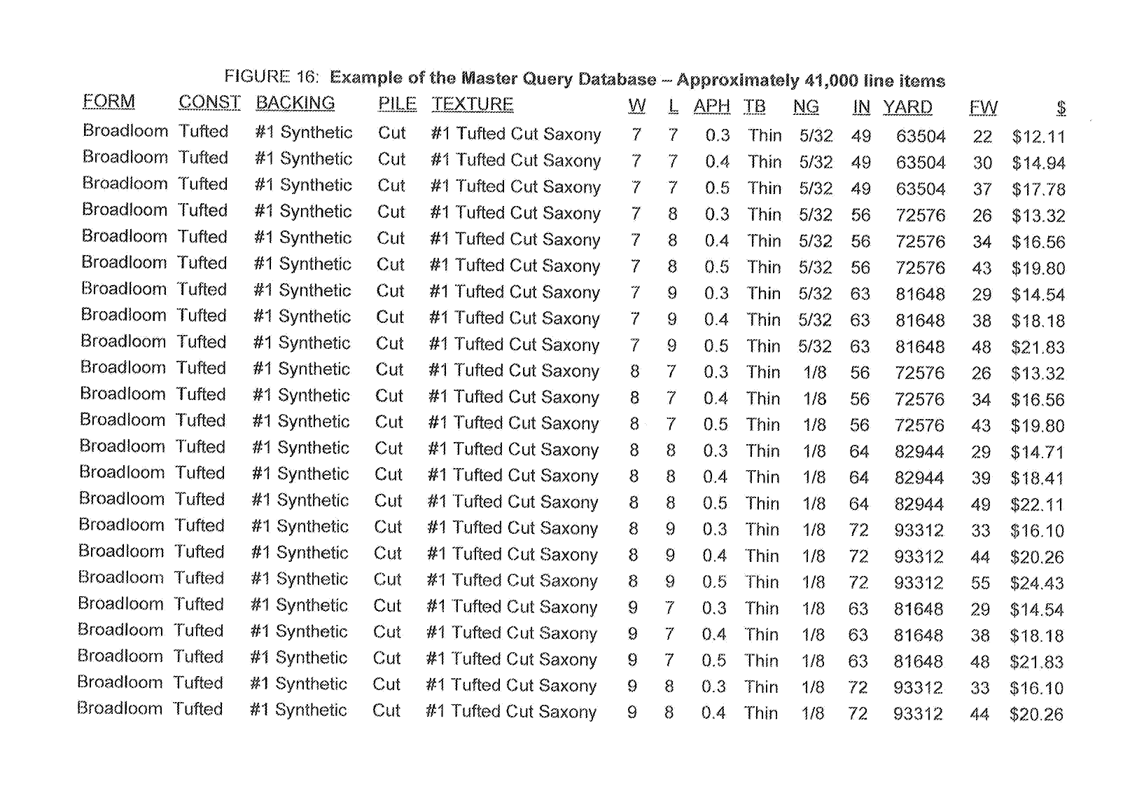

The master query product database 35 may comprise a series of tables containing virtually ail possible configurations of the characteristics. FIG. 16 illustrates an example of a master query product database 35. In this example, the first line may describe a very sparse (light weight) density Saxony product that is absolutely unique in the database. In this case, the described product's FORM is “Broadloom”; the CONSTRUCTION is “Tufted”; the BACKING is “Synthetic”; the PILE CONFIGURATION is “Cut”; the TEXTURE is “Saxony”; the STITCH RATE WIDTH is “7”; the STITCH RATE LENGTH is “7”; the AVERAGE PILE HEIGHT is “0.3”; and the TUFT BULK is considered “Thin”.

Based on these unique characteristics, the master query product database 35 may also show that the needle gauge for a product would be “ 5/32” inches. It may also denote that the tufts per square inch is “49”. This may be calculated by multiply the two stitch rate values. The next column may be a calculated tufts per square yard; “63504”. This may be calculated by multiplying the Tufts/SqYd by 1296 (number of square inches in a square yard). The next column may show the estimated face weight of the product. In some embodiments, this calculation may be processed offline (e.g., outside of the query system's primary automated process of matching the 11 query answers to the master database and finding a match to all elements) through another database with the sole purpose of calculating an estimated face weight by multiplying the Tufts/SqYd by a weight value equal to a single tuft of fiber unique to this carpet type. In other embodiments, this calculation may be processed within system 100.

The weight value of the single tuft may be calculated by taking a known carpet product and mathematically deducing the single tuft weight by applying the following formula:

One inch Stitch Rate (Width)×One inch Stitch Rate (Length)=Tufts/SqIn

Tufts/SqIn×1296=Tufts/SqYd

Tufts/SqYd/Known Face Weight (All fiber)×0.80=Single Tuft Weight.

The next column may denote the suggested retail value of a square yard of the product. This may be calculated by multiplying the Tufts/SqYd by a price value equal to a single tuft of fiber unique to this carpet type. Combined, all 14 data elements denoted in each line may describe a unique product in terms of Form, Construction, Backing, Pile Configuration, Texture, Stitch Rates, Pile Height, Tuft Bulk, Needle Gauge, Tufts/SqIn. Tufts/SwYd and resultant calculated Face Weight and Suggested retail value per square yard. By closely examining the first two lines (products) in the Query Match Database, one may notice a difference in the two products due to an Average Pile Height difference of 0.1 inch. This differentiation may have an effect on the calculated face weight (22 oz compared to 30 oz) and the suggested retail price ($12.11 compared to $14.94) thus creating another unique product.

Through the remaining lines, one may note the variations in the values denoted. The creation of this master query product database 35 was done to help itemize every possible combination of the values possible. In the case of the texture type, “Saxony”, there are 405 possible combinations of the query variables, thus creating 405 possible unique products within the “Saxony” category. This itemization may he achieved by applying each iteration of each characteristic variable until each combination was captured in the database.

### EXAMPLE

### Tufted Cut Saxony

Possible variables of FORM: 1

Possible variables of CONSTRUCTION: 1

Possible variables of BACKING: 5

Possible variables of PILE CONFIGURATION: 1

Possible variables of TEXTURE: 1

Possible variables of STITCHES PER INCH WIDTH: 3

Possible variables of STITCHES PER INCH LENGTH: 3

Possible variables of PILE HEIGHT SHORT: 4

Possible variables of PILE HEIGHT LONG: 4

Possible variables of TUFT BULK: 3

As stated above, taking all possible combinations of these characteristics into unique sequences, the product category of “tufted cut Saxony” results in 405 unique combinations—Very sparse, light weight to very dense, heavy products.

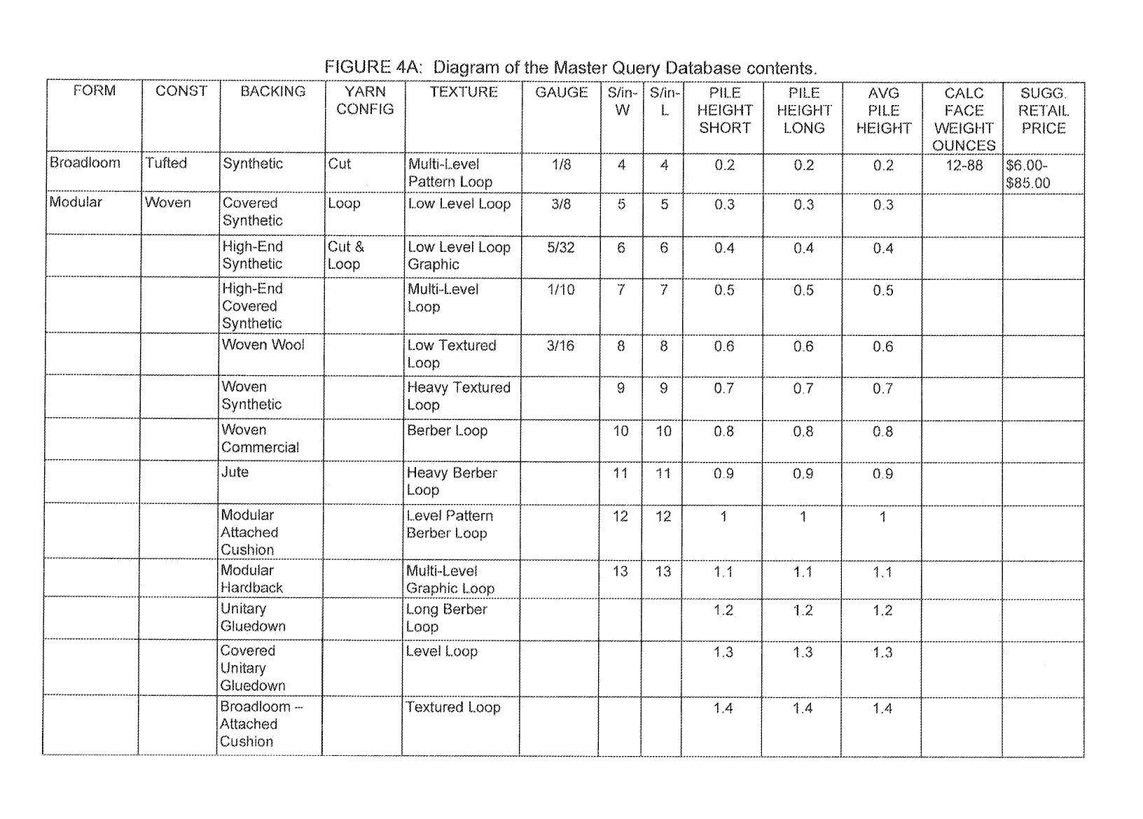

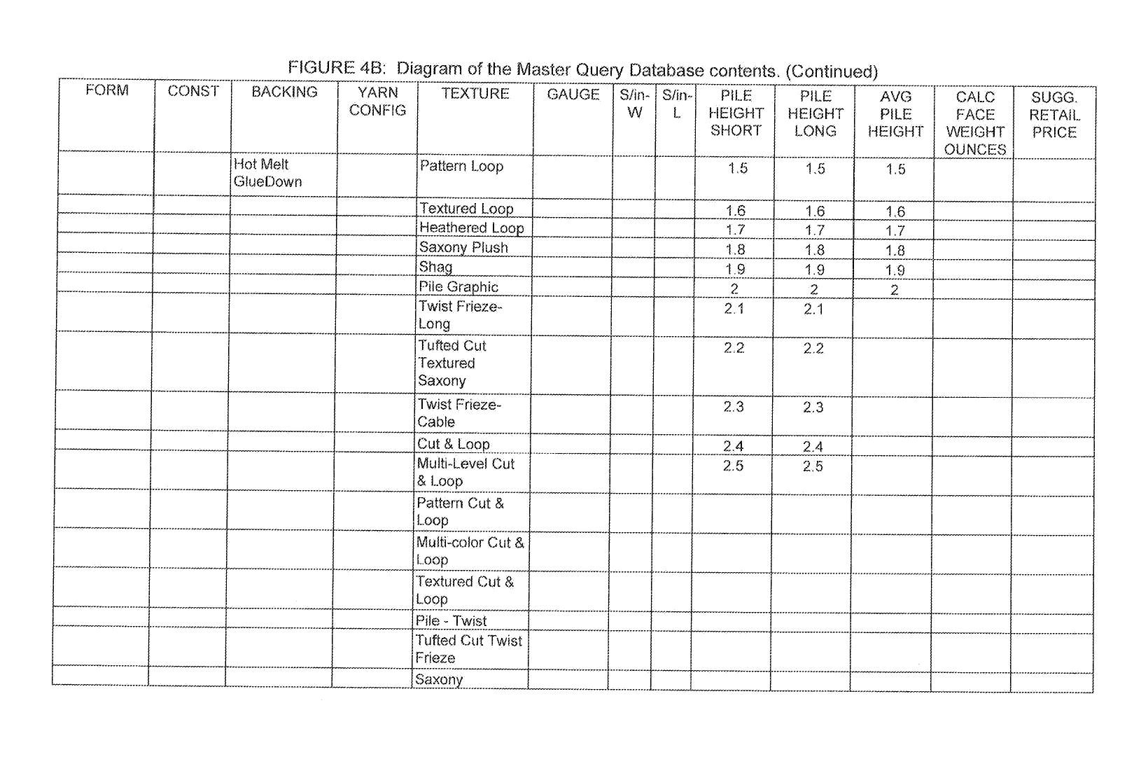

FIGS. 4A-4B illustrate an example of the contents of the master query product database 35. There may be more than 41,000 unique product possibilities in the master query product database 35 comprising: FORMs, CONSTRUCTIONS, BACKINGS, PILE CONFIGURATIONS, TEXTURES, STITCHES PER INCH WIDTH, STITCHES PER INCH LENGTH, PILE HEIGHT SHORT, PILE HEIGHT LONG, TUFT BULK.

Within the query process relating to the measurement of the pile heights, system 100 may calculate an “average pile height” to be matched as one of the characteristics in the master query product database 37. For example, if the user of the system enters “0.3” as the measurement for the query relating to “Pile Height−Short” and enters “0.5” as the measurement for the query relating to “Pile Height−Long”, the system 100 may calculate the average pile height of the product to be “0.4”.

The type of fiber the pile yarn is manufactured from may play an important part in the overall value calculation. 95+% of all carpet is made of either Nylon, Olefin or Polyester. Since it is virtually impossible to identify the fiber type in the field, system 100 may use manufacturing data to help identify the probability of the fiber type. For example, tufted cut-Saxony carpets may be made of Nylon 87.4% of the time—the remainder being Polyester. As such, the pricing logic may include this fact when displaying the suggested retail price. Conversely, wool, the most expensive fiber, may only represent 2% of all carpets manufactured. Based on the damaged carpet construction type and backing identified in the process, system 100 may notify the user when it determines that the damaged carpet may be wool. In such cases, the user may be advised to send a sample in to a qualified laboratory for a detailed evaluation.

In addition to the above process being completed, in some embodiments, advertising may be provided to the owner of the damaged product related to the damaged product. The information about the matching product found through the assessment carried out above may be utilized in determining which advertising would be most effective.

While various embodiments have been described above, it should be understood that they have been presented by way of example, and not limitation. It will be apparent o persons skilled in the relevant arts that various changes in form and detail can be made therein without departing from the spirit and scope. In fact, after reading the above description, it will be apparent to one skilled in the relevant arts how to implement alternative embodiments. Thus, the present embodiments should not be limited by any of the above described exemplary embodiments. In particular, it should be noted that, for example purposes, the above explanation has focused on the examples of a beacon code assignment system. However, one skilled in the art will recognize that embodiments of the invention could be other types of applications, such as, for example, other transportation applications.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

It should be noted that the term “including” and “comprising” should be interpreted as meaning “including, but not limited to”.

In addition, it should be noted that, if not already set forth explicitly in the application (e.g., specification, figure, claims), the term “a” should be interpreted as “at least one” and “the”, “said”, etc. should be interpreted as “the at least one”, “said at least one”, etc.

It is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A computerized process, comprising:
performing processing associated with storing characteristics of possible products in an electronic database in communication with a processor;
performing processing associated with accepting user input related to a product's characteristics;
performing processing associated with matching, utilizing a retail pricing calculation engine, the accepted user input related to the product's characteristics to the electronic database of characteristics of possible products to find a matched product; and
performing processing associated with determining, using the retail pricing calculation engine, a valuation for the a matched product.

2. The process of claim 1, wherein the valuation accounts for the suggested retail replacement cost value based on geographic location.

3. The process of claim 2, wherein the suggested retail replacement cost contains retail pricing data derived from actual market information and relating relationally to the products in the electronic database.

4. The process of claim 1, wherein the following product characteristics are taken into account: TYPE, FORM, CONSTRUCTION, BACKING, PILE CONFIGURATION, TEXTURE TYPE, STITCHES/INCH WIDTH, STITCHES/INCH LENGTH, PILE HEIGHT−SHORT, PILE HEIGHT−LONG, TUFT BULK CALCULATED FACE WEIGHT, or SUGGESTED RETAIL VALUE, or any combination thereof.

5. The process of claim 1, further comprising:
performing processing associated with accepting user input identifying an owner of the product and/or an entity that will pay the replacement cost.

6. The process of claim 5, wherein the entity that will pay the replacement cost comprises a property insurance carrier and/or a restoration specialist.

7. The process of claim 1, wherein the user input related to a product's characteristics comprises input based on visual, tactile, measured, or web-based information, or any combination thereof.

8. The process of claim 1, further comprising:
performing processing associated with displaying advertising related to the product.

9. The process of claim 1, wherein the product is a soft surface product.

10. An electronic system, comprising:
a processor configured for:
performing processing associated with storing characteristics of possible products in an electronic database in communication with the processor;
performing processing associated with accepting user input related to a product's characteristics;
performing processing associated with matching, utilizing a retail pricing calculation engine, the accepted user input related to the product's characteristics to the electronic database of characteristics of possible products to find a matched product; and
performing processing associated with determining, using the retail pricing calculation engine, a valuation for the a matched product.

11. The system of claim 10, wherein the valuation accounts for the suggested retail replacement cost value based on geographic location.

12. The system of claim 11, wherein the suggested retail replacement cost contains retail pricing data derived from actual market information and relating relationally to the products in the electronic database.

13. The system of claim 10, wherein the following product characteristics are taken into account: TYPE, FORM, CONSTRUCTION, BACKING, PILE CONFIGURATION, TEXTURE TYPE, STITCHES/INCH WIDTH, STITCHES/INCH LENGTH, PILE HEIGHT−SHORT, PILE HEIGHT−LONG, TUFT BULK, CALCULATED FACE WEIGHT, or SUGGESTED RETAIL, VALUE, or any combination thereof.

14. The system of claim 10, wherein the processor is further configured for:
performing processing associated with accepting user input identifying an owner of the product and/or an entity that will pay the replacement cost.

15. The system of claim 14, wherein the entity that will pay the replacement cost comprises a property insurance carrier and/or a restoration specialist.

16. The system of claim 10, wherein the user input related to a product's characteristics comprises input based on visual, tactile, measured, or web-based information, or any combination thereof.

17. The system of claim 10, wherein the processor is further configured for:
performing processing associated with displaying advertising related to the product.

18. The system of claim 10, wherein the product is a soft surface product.
